(19) United States
(12) Patent Application Publication
(10) Pub. No.: US 2007/0014537 A1
(43) Pub. Date: Jan. 18, 2007

(54) COLLECTING AND ANALYZING DATA FROM SUBJECT MATTER EXPERTS

(76) Inventors: Darren L. Wesemann, North Salt Lake, UT (US); Jeffrey Hays, Sandy, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/425,372

(22) Filed: Jun. 20, 2006

Related U.S. Application Data
(63) Continuation-in-part of application No. 11/383,921, filed on May 17, 2006.
(60) Provisional application No. 60/682,361, filed on May 18, 2005.

(51) Int. Cl. H04N 7/00

(52) U.S. Cl. 386/95

(57) ABSTRACT

Collecting content from subject matter experts. A knowledge base includes common content that can be used by SMEs to define a philosophy. A user interface present filtered portions of the common content and provides for direct entry. The content input by the SME is stored in the knowledge base. Individualized media content for use by a subscriber can then be generated by searching for content such as media clips having attributes that match the subscriber's attributes. Further, the content input by the SME can be modeled such that individualized media content can be dynamically generated to account for the particular situation of a given subscriber.

### CROSS-REFERENCE TO RELATED APPLICATIONS

This application is a continuation-in-part of U.S. patent application Ser. No. 11/383,921, filed May 17, 2006 and entitled MIXING AND PRODUCING INDIVIDUALIZED MEDIA FILES, which application claims the benefit of U.S. Provisional Application Ser. No. 60/682,361 filed May 18, 2005. The foregoing applications are incorporated by reference in their entirety.

### BACKGROUND OF THE INVENTION

1. The Field of the Invention

The present invention relates to the field of media content. Embodiments of the invention relate to systems and methods for collecting and/or delivering content from subject matter experts to subscribers and more particularly to systems and methods for modeling input from subject matter experts to dynamically generate personalized media content.

2. The Relevant Technology

People's interests vary widely and people are often trying to improve themselves or try new things. Some people take classes to learn a new skill or to study a subject in more depth. Other people travel to various locations to experience different cultures and places. Some people exercise to get in shape or to look better. Fitness clubs, college, and travel are examples of these areas. One of the best ways to achieve good results is to seek training or learning from someone that is an expert in the relevant field. For example, college provides a person with access to professors who are knowledgeable in various subjects, travel agents are familiar with trip destinations and can provide advice about where to go and what to see, and fitness trainers are able to improve the way one exercises.

A common element in each of these areas is the presence of a subject matter expert and is often seems that people who take advantage of the experience and expertise of subject matter experts achieve higher satisfaction and better results. For example, a person working with an exercise trainer is more likely to achieve the desired results than when working out on their own.

More generally, subject matter experts often have the ability of being able to identify a preferred course of conduct or a preferred course of study. Subject matter experts also know what needs to be done in order to reach a particular goal. Unfortunately, seeking and obtaining the service of a subject matter expert can often prove to be both difficult and expensive. For example, the increasing cost of personal trainers coupled with the high demand for personal trainers is making it difficult to find personal trainers with openings for new subscribers. As a result, may subscribers are left without the support and instruction needed to achieve desired fitness goals.

One attempt to fill this void can be found, for example, in DVDs, videocassettes, and the like. For example, people that want to workout in their own homes can easily secure the necessary exercise equipment and can exercise to a workout DVD. Similarly, people who want to travel can buy books or rent DVDs about their destination. Even though the DVD or book may have content that is prepared by a subject matter expert, it is difficult if not impossible to alter the content of the DVD according to the needs of the user. Further, there is no guarantee that the DVD or book is individualized for each user. In other words, printed media such as books and DVDs, etc., are typically geared for a mass audience rather than individualized for a particular user.

Thus the ability to bring the expertise of a subject matter expert in a dynamic way into the activities of a user is lacking in existing technology. There is therefore a need to create instructions and personalized media content in a portable medium to allow a subscriber to take a personalized media content with them in any location.

### BRIEF SUMMARY OF THE INVENTION

These and other limitations are overcome by embodiments of the invention which relate to media content and more particularly to systems and methods for collecting content from subject matter experts that can be include in individualized media content delivered to subscribers. Note that the Summary is provided to introduce a selection of concepts in a simplified form that are further described below in the Detailed Description.

Embodiments of the invention operate in an environment that delivers customized media content to subscribers. Using information provided by subscribers, specific content from one or more subject matter experts can be identified, selected, and included in an individualized media content. Further, embodiments of the invention ensure that the individualized media content can be updated as the subscriber or user advances or changes. The ability to update can be from the subject matter expert or in response to progress made by the subscriber.

According to one embodiment, data or content may be collected from subject matter experts and incorporated into a knowledge base. The collection of content from a subject matter expert often begins when a web application is accessed by a subject matter expert, who is then presented with a user interface that may include multiple fields. The fields can be pre-populated (e.g., drop down menus) with common content (provided by other subject matter experts) from the knowledge base or can be input by the subject matter expert directly (text entry fields). In each case, the expertise or philosophy of the subject matter is being extracted as the subject matter expert organizes the building blocks included in the common content via the user interface.

The server receives the content input into the various fields of the user interface. Then the content is incorporated into a knowledge base from which the individualized media content delivered to subscribers is generated.

In one embodiment, the content is stored as a media clip or is associated with a media clip that can also be provided by the subject matter expert. The individualized media content ultimately provided to a subscriber often includes several media clips that have been mixed to generate the individualized media content.

Additional features and advantages of the embodiments disclosed herein will be set forth in the description which follows, and in part will be obvious from the description, or may be learned by the practice of the invention. The features and advantages of the embodiments disclosed herein may be realized and obtained by means of the instruments and combinations particularly pointed out in the appended claims. These and other features of the embodiments disclosed herein will become more fully apparent from the following description and appended claims, or may be learned by the practice of the embodiments disclosed herein as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 illustrates an exemplary environment for implementing embodiments of the invention;

FIG. 2 illustrates one embodiment of a grid type user interface that can be used to access or to interact with a knowledge base;

FIG. 3 illustrates one embodiment of a knowledge base that includes subscriber data, common content, and data from a subject matter expert;

FIG. 4 illustrates an exemplary system and method for collecting data from a subject matter expert;

FIG. 5 illustrates one embodiment of a grid based user interface to collect a method of a subject matter expert that reflects a philosophy of the subject matter expert;

FIG. 6 illustrates a flow diagram for modeling content received from a subject matter expert; and

FIG. 7 is a block diagram illustrating an example of systems and methods for collecting and modeling content received from subject matter experts.

### DETAILED DESCRIPTION OF THE INVENTION

Embodiments of the invention relate generally to systems, methods, and/or computer program products for delivering individualized media content to a subscriber or other recipient. The individualized media content is typically generated from a knowledge base that stores incorporates content from different sources such as subject matter experts. Once the content has been incorporated into the knowledge base, the knowledge base can be accessed based on certain parameters, such as a subscriber's attributes, to identify specific instances of the content, such as media clips. The media clips selected or identified from the knowledge base can then be mixed to produce the individualized media content ultimately delivered to the subscriber.

The knowledge base includes content in various forms and formats from multiple users or entities. One of the users or category of users that provides content that is incorporated into the knowledge base is a subject matter expert and embodiments of the invention more particularly relate to systems and methods for receiving or incorporating content from subject matter experts into the knowledge base.

As used herein, media content is one embodiment of an individualized media file that can include audio and/or video content. Typically the media content includes one or more media clips, each of which may include audio and/or video content, that are selected and then mixed according to some criteria, such as a subscriber's attributes. The content received from the subject matter experts is incorporated into the media clips such that, when the individualized media content is delivered, it includes specifically selected content from subject matter experts. Advantageously, users of the media content can receive the benefit of content provided by various subject matter experts. In this manner, each subscriber can receive individualized media content.

Embodiments of the invention generate individualized media content that can be directed to a wide variety of activities or subjects. The knowledge base can be created with different subjects in mind and the subject matter experts that contribute to a particular knowledge base are preferably in that subject matter. The individualized media content can cover or relate, by way of example only, to any instructional or entertainment-type media production.

Embodiments of the invention are described as they relate to the subject of exercise. In this example, the subject matter experts that contribute to the knowledge base include those that are knowledgeable about exercise, such as exercise trainers and the like.

One of skill in the art can appreciate that the knowledge base can be related to other subjects. For example, media content related to a course on algebra may include content from a subject matter expert such as a professor or teacher. Media content related to a trip may include content from a subject matter expert such as a travel guide. One of skill in the art can appreciate, with the benefit of the present disclosure, that the invention can be practiced in many with many different subjects, including various sessions and activities, in addition to the subject of exercise.

A subscriber that accesses and uses the system described herein ultimately receives individualized media content. When the subject is exercise, the media content delivered to a subscriber may be a workout routine that includes content from one or more subject matter experts. When the subject or activity is cooking, education, outdoor-related, travel-related, instructional, etc., a knowledge base can be created that incorporates and models the expertise and knowledge of subject matter experts. As a result, subscribers and other users can receive individualized media content for any given subject or activity. Embodiments of the invention can therefore deliver the expertise of a subject matter expert in the form of media content for any subject, activity, session, and the like or any combination thereof.

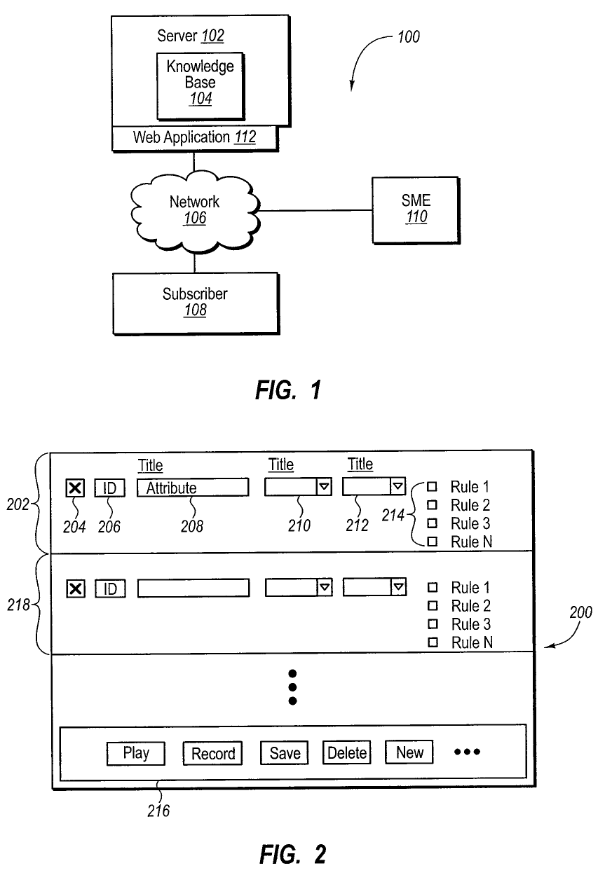

FIG. 1 illustrates an exemplary environment for implementing embodiments of the invention. In this example, FIG. 1 illustrates a server 102 that is accessible over a network 106, which may be the Internet. The server 102 represents one or more server computers or a server farm. The server includes or has access to the knowledge base 104, which as described above, stores content including media clips. The knowledge base 104 may be a relational database that is used to provide relationships between the various content or media clips. Thus, the knowledge base 104 may include multiple tables of information and the various tables can be related. Often, metadata can also be included in the knowledge base 104. The metadata can be used, for example, to identify specific content or media clips based on specified criteria.

In this example, server 102 is accessed through web applications 112 over the network 106. The web applications 112 can include specific interfaces that are adapted to the user or entity accessing the server 102 and/or the knowledge base 104. For example, the interface presented to a subject matter expert (SME) 110 may be different from the interface provided to the subscriber 108. The web pages presented to the SME 110 are designed to extract information from the SME 110 that, in one embodiment, define the philosophy of the SME 110 or the expertise in the context of the subject currently stored in or added to the knowledge base 104.

In one embodiment, the web application 112 enables the SME 110 to use the common content currently stored in the knowledge base 104 as building blocks to define the philosophy or methods of the SME 110. In some instances, there are certain SMEs that generate the common content or building blocks of the knowledge base 104. The common content can then be used by other SMEs such as the SME 110 to define the specific philosophy or methods of the SME 110. Other SMEs can also access the server 102 through the web applications 112 to generate content using the building blocks. Thus, the knowledge base continues to grow and improve from the contributions of various SMEs. In some instances, information provided by the SME 110 can be normalized and converted to new building blocks for use by other SMEs.

The web application 112 typically permits a subscriber or SME to interact with the knowledge base 104. In one example, the web application 112 presents a grid like interface to the subscriber, SME, or other user. The grid interface is typically adapted to the identity of the user. Thus, the interface presented to a subscriber may be different from the interface presented to an SME. More particularly, the interface presented to an SME 110 may be designed to extract or collect information or content that can be added to the knowledge base 104 while the interface presented to a subscriber may be designed to collect information that is then used to search or access the knowledge base 104 for media clips that can be included in the individualized media content later delivered to the subscriber.

FIG. 2 illustrates one embodiment of a grid interface 200. Using the grid interface 200, an SME can provide and/or select specific information that is consistent with the philosophy of the SME. One of skill in the art can appreciate that the specific grid interface presented to a user can vary according to the task being performed. For example, the interface presented to record audio may be different from the interface used to recommend or identify specific equipment used for a given exercise. The grid interface 200 is presented by way of example only to described the principles and methods of collecting information from a user such as an SME or subscriber.

FIG. 2 illustrates a grid interface 200 including at least one row 202. Each row is typically directed to specific exercise or to a particular method, etc. Multiple rows, represented by the row 218 can also be shown to a user. The row 202 provides a delete button 204, and ID field 206, an attribute field 208, fields 210 and 212 with drop down menus, and rules 214 that are selectable. Some of the various fields, drop down menus, click boxes, and the like are optional and can depend on the type of data that is being entered. In addition, some of the fields may be pre-populated from corresponding tables in the knowledge base. One of skill in the art that the number of drop down menus, static fields, text entry fields, radio boxes, and the like or any combination thereof can be generated according to the type of information being entered.

Assume, for example, that a warmup or warmdown step is being generated and is defined by the various fields illustrated in the interface 200 of FIG. 2. More particularly, this example is used to select a goal for a given exercise step. The primary attribute is often displayed in the first field and related attributes are displayed in subsequent fields. In this example, the primary attribute 208 is further refined or further defined by the drop down fields 210, 212 and the rules 214.

For example, the attribute 208, which can be loaded as a drop down menu from a goal table in the knowledge base, may identify a particular goal of some step of an exercise routine. Thus, a user (such as a subject matter expert) can select a particular goal from the a attribute 208. The fields 210 and 212 can then be loaded from content included in a table stored in the knowledge base. In this case, however, the content is filtered based on a type, such as a type associated with the attribute 208. If the grid interface is being used to set a goal for a warmup or warmdown routine, then the fields 210 and 212 may be filtered based on these types. As a result, the available content (which may include media clips) presented in the fields 210 and 212 are those that have been associated with the selected goal in the knowledge base and/or that satisfy the filter type. In this example, the fields 210 could then be used to identify a particular warm up media clip and the field 212 could be used to identify a warmdown media clip. The rules 214 are optional and may apply in certain instances.

In this example, the common content or building blocks of the knowledge base have been filtered and then presented in the fields of the grid interface 200. The SME is then able to define his or her philosophy in the way that the common content or building blocks are combined into a part of an exercise routine or part of a media clip. More particularly in one embodiment, the selections of an SME made in the row 202 of the grid interface may define a media clip for a warm up routine. In a similar manner, media clips for other parts of an exercise routine can be defined by an SME. Then, the resulting media clips, if selected for a subscriber, can be combined into media content that is delivered to the subscriber.

With continued reference to FIG. 2, the command list 216 enables a user to initiate various commands. The record command, for example, enables an SME to record instructions (in an audio and/or video form, for example) to be included in a media clip. The play command enables the SME to review what has been previously recorded. The save, delete, and new commands are used to perform management of the content being provided or to manage the content currently stored in the knowledge base. If the philosophy of the SME cannot be achieved with what is available, another command may be included that enables an SME to request additional content be added to the knowledge base.

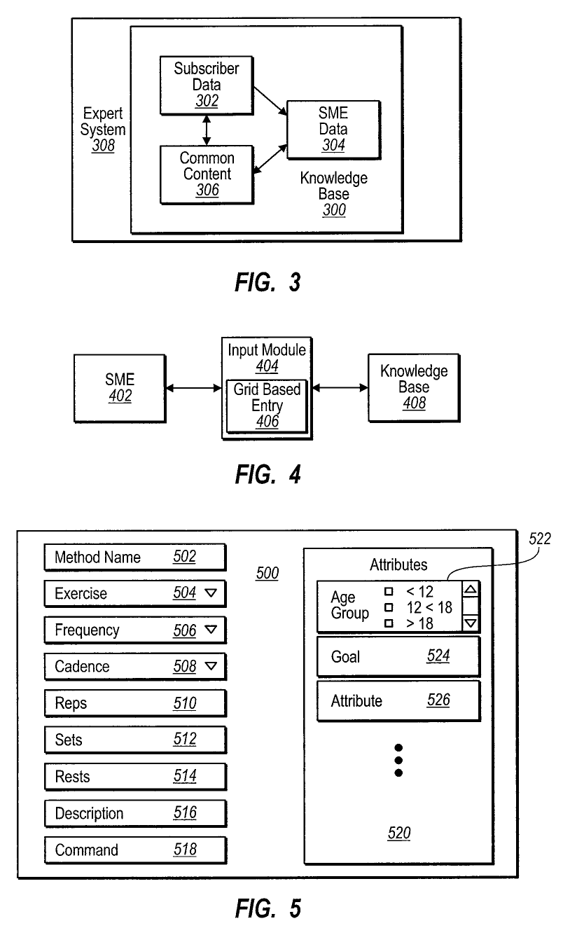

FIG. 3 provides a generalized illustration of a knowledge base 300, which is one embodiment of the knowledge base 104. In this example, the knowledge base 300 stores SME data 304, subscriber data 302, and common content 306. The common content 306 is one embodiment of the building blocks of the knowledge base 300 that is typically provided by a first SME or by a group of SMEs that are responsible for generating, updating, maintaining, etc., the common content 306.

Before describing the collection of data from an external SME that provides the SME data 304, a description of the common content 306 is first presented. Further, the following description is described with reference to exercise data, but one of skill in the art can appreciate other areas or subjects that can be included in the knowledge base in view of the teachings contained herein. For example, course of study data, travel data, guided tour data, and the like are examples of data that can be described by activity and then augmented by the SME data 304.

In one embodiment, an exercise routine can be defined as a series of steps or parts, such as preworkout, warmup, exercise, set, warmdown, and postworkout. Each step can be associated with or defined by a particular media clip.

In general, media clips are maintained in the knowledge base 300. Each media clip has attributes, that may include, but are not limited to, a name that is generally presented to subscribers or others, a physical file name, a step, and a description. A subject matter expert can delete, update, or add media clips and the like or perform other operations commonly available in a relational database. In one embodiment, the media clips can be accessed via a grid like interface.

The media clips or other content can also be associated with other data in the knowledge base. One attribute, referred to as a warm attribute, can be defined in terms of a goal (e.g., fat loss, fitness, build muscle, stress reduction, medical body shaping, sport specific,), a step, a warmup media clip, and a warmdown media clip. Both the warmup media clip and the warmdown media clip can be recorded. For example, these attributes may be recorded by an SME (such as a trainer).

FIG. 4 illustrates an exemplary for providing knowledge to a database for collecting content from an SME. In this example, an input module 404 operating, for example, at a server computer interacts with the SME 402 to provide at least a grid based entry 406. Once the SME 402 enters data into the grid based entry 406, the entered content or data can be incorporated into the knowledge base 408.

The grid based entry 406 provides one embodiment of a user interface for SMEs to define their unique philosophies. An SME can select predefined content, such as exercises and attributes. The SME can also add pre-workout and post-workout media content to generate a customized feel for a subscriber.

When collecting information from an SME, the server typically receives a request for access. The server has the option of authenticating the SME (using logon name and password for example). Once authenticated, an SME module (included in the Web applications) generates the user interface that is then presented to the SME. The user interface may be presented via a browser.

SMEs can provided recorded media (audio and/or video) that can be performed at any part of an exercise routine. The media can be pre-recorded and simply transmitted to the server computer or the user interface can record (using a web cam and/or microphone) the input from the SME. Often, the recorded media can be included in a particular step of an exercise routine.

An SME often provides methods to the knowledge base. In this context, a method defines a particular exercise in terms of various attributes. FIG. 5, for example, illustrates an interface 500 that includes various fields can be used by an SME to define a method. Some of the fields are populated from tables in the knowledge base, other fields may include text entry fields, radio buttons or check boxes, etc.

The field 502 identifies a method name. The field 504 is typically populated from a table in the knowledge base (from the comment content, for example) and an SME can then select the exercise for the method. Note that the interface 500 may change once a particular exercise is selected. The fields 504, 506, 508, 510, 512, 514, and 516 can then be used to identify additional attributed to further define the selected exercise. The frequency field 506, which may also be populated from a table in the knowledge base or may be adapted to receive an entry directly from the SME, identifies how often the exercise should be performed (i.e., days per week). The cadence field 508 can identify a timing of an exercise (i.e., number of seconds lifting/number of seconds lowering) when applicable.

The field 510 is a number of repetitions and the field 512 is a number of sets. The field 514 can define rests in terms of time. The field 516 is a text entry field where the SME can provide a description of the exercise according to the philosophy of the SME. The command field 518 typically provides inputs for an SME to add, delete, record media, and the like or any combination thereof.

The attributes 520 provide further refinement of an SME's philosophy for a given method and can also be loaded from tables in the knowledge base. For example, an SME can identify an age group 522, a goal 524 of the method, and other attributes 526. Exemplary attributes may include, but are not limited to, medical history, experience level, endurance level, fitness level, availability, and the like or any combination thereof.

An SME has the ability to update, add, or delete methods. For example, another user interface may present all of the methods associated with a particular SME by filtering using the SME ID. This interface can facilitate the process of selecting, adding, deleting, or updating a method.

As described above, the user interfaces presented to an SME can facilitate the collection of data from the SME. However, it is very difficult to collect information from SMEs that account for all of the potential permutations. Embodiments of the invention further relate to modeling the data collected from the SME. Embodiments of the invention extract the methodology or philosophy of an SME from the content that is submitted by the SME.

In one example, the user interfaces described herein can be used to collect samples of content from and SME given a particular scenario. Embodiments of the invention model the content that is collected and dynamically adapt the content to the specific requirements of each subscriber or user.

As described previously, some of the content provided by an SME is variable. The modeling of the content identifies these variabilities along with why a variability is present. Often the content varies according to the attributes of the subscriber. These variable aspects of the SME provided content can be extracted and saved for use in dynamically generating user scripts.

For example, an SME may provide a content that describes a weightlifting exercise and the SME may describe the weightlifting exercise for an advanced subscriber using a first weight and then using a second weight for a beginner. This variability in weight is based on the expertise of the user, which is an attribute of the user in one example. Thus, the variability is identified along with the reason for the variability. This type of content can be stored in the knowledge based and later used in the dynamic generation of media content. In other words, by identifying the variables in the content and/or by identifying the reasons for the variability, the various circumstances of each subscriber can be accommodated without requiring the SME to provide content for each and every case or potential permutation of the content.

In one embodiment, content from an SME, such as a particular exercise, can be broken down into mini scripts that are related to variability and/or to user attributes. When a subscriber later accesses the system to obtain individualized media content, the system can access these mini scripts or clips based on the attributes of the user and/or the variability in the scripts and/or the reasons for the variability in the scripts or clips. In this manner, embodiments of the invention can model the content of an SME and dynamically generate media content that is adapted for a particular subscriber.

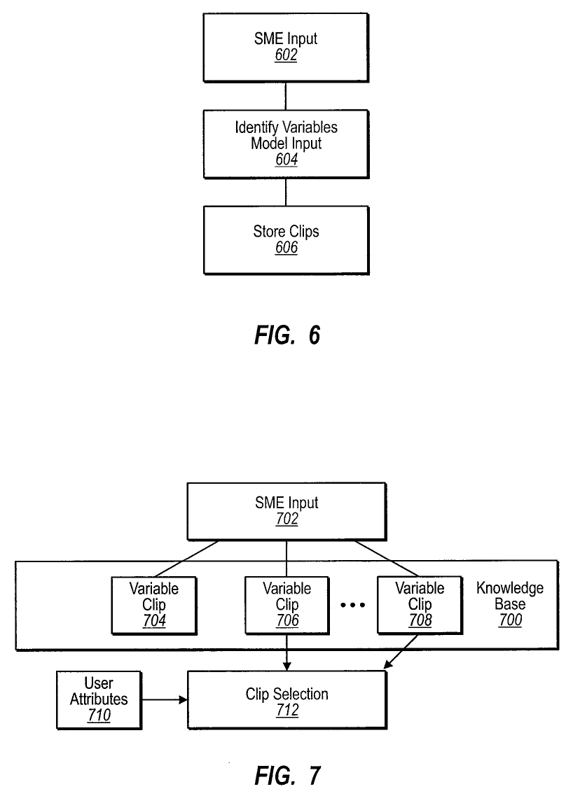

FIG. 6 illustrates a flow diagram for receiving content from an SME. The method typically begins by receiving 602 input from an SME. One of skill in the art can appreciate that the content may already be stored in the knowledge base or is new content being received from an SME, or is from another source. Next, the variables in the content are identified 604 and the content is modeled.

Identifying the variables and modeling the content can include, as previously stated, identifying those aspects of the SME provided content that are variable along with whey those aspects of the content vary. In one embodiment, the variable aspects of the content are identified based on potential attributes of the subscriber, which are often predefined in the system.

After the variable aspects have been identified, the clips are stored 606 in the database. Modeling the content from the SME enables the system to dynamically generate media content that includes the relevant clips from the knowledge base.

FIG. 7 further illustrates this process. The SME input 702 is analyzed and stored in the knowledge base 700 as variable clips 704, 706, and 708. In one example, the variable clips represent a decomposed script or decomposed content from an SME. The decomposed content is then stored in the knowledge base 700 and can later be used to construct customized and/or dynamic content.

Each of the clips, as described above, may reference a variable in the content provided by the SME and may also identify the reason for the variability. This type of information Using the user attributes 710, in one example, the clip selection 712 involves access the variable clips, such as the clips 706 and 708, to generate a media content that dynamically accounts for a particular subscriber.

In an expert system, such as an expert system 308, therefore provides a knowledge base 300 as well as the queries and rules processing needed to produce a workout sequence that conforms to a subscriber's goals, attributes, status, selected trainer, etc.

For example, a SME may provide content or input 702 with a particular subscriber in mind. The content or input 702, such as an exercise, may be geared, for example, for a 32 year old female whose goal is to lose weight. With this person in mind, the SME can provide the content 702. In a similar manner, the SME can provide other content that may reference other contexts or take other variables into account. One of the variables taken into account may be, for example, the medical history of the subscriber. With reference to FIG. 7, the variable clip 704 may refer to a starting weight in an exercise involving the legs for a 32 year old female. The variable clip 708, on the other hand, may account for the medical history of a subscriber in a different context, for example, in relation to another exercise.

When a subscriber then requests personalized or individualized media content, the user attributes 710 can be matched to generate the appropriate media content even though the SME did not provide content specifically for that subscriber's situation. For example, the subscriber may be a 32 year old female with a goal of losing weight. However, the subscriber has a bad knee indicated in her medical history. Thus, the variable clip 714 may not be appropriated. However, the variable clip 708, which addresses this particular medical issued can be used in the generation of the media content in order to dynamically generate the media content for the subscriber that accounts for her medical history.

Thus, the expert system can model the content from the SMEs in a manner that permits media content to be generated dynamically. The expert system looks at the variability in the scripts or content provided by an SME. The reason for variability are often related to the subscriber attributes that are matched to actual subscribers. When media content is generated, the subscriber attributes can be used as described above to identify clips that are included in the media content.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a system that delivers media content including an individualized media file for a particular subject, a method of collecting data from a subject matter expert for the subject of the media content, the method comprising:
presenting a user interface to a subject matter expert, the user interface including one or more fields;
receiving content from the subject matter expert into the one or more fields; and
incorporating the content received from the subject matter expert into a knowledge base.

2. The method of claim 1, wherein presenting a user interface to a subject matter expert further comprises presenting a grid based user interface.

3. The method of claim 1, wherein at least one of the fields is a drop down menu, further comprising populating the drop down menu with data from a table in the knowledge base.

4. The method of claim 1, wherein receiving content from the subject matter expert further comprises:
receiving recorded media from the subject matter expert for a particular subject;
associating the recorded media with a particular portion of the subject.

5. The method of claim 1, wherein receiving content from the subject matter expert further comprises receiving at least one method from the subject matter expert.

6. The method of claim 5, further comprising:
presenting the subject matter expert with common content from the knowledge base; and
enabling the subject matter to enter the content to reflect a philosophy of the subject matter expert.

7. The method of claim 6, further comprising receiving at least one command from the subject matter expert for maintenance of the content provided by the subject matter expert, the at least one command including one or more of a save command, a new command, a delete command, and a record command.

8. The method of claim 6, further comprising selecting one or more methods from the subject matter expert for inclusion in media content delivered to a subscriber based on a match between subscriber attributes and attributes of the one or more methods, wherein the one or more methods are embodied in media clips.

9. The method of claim 8, further comprising mixing the selected media clips into media content and delivering the media content to a subscriber.

10. The method of claim 8, wherein the content is exercise content and wherein a method comprises a plurality of attributes that are set by the subject matter expert.

11. The method of claim 10, wherein the a first attribute is selected in a first field of the user interface and wherein subsequent fields in the user interface are determined and populated from tables in the knowledge base according to the selection of the first field.

12. The method of claim 11, wherein the plurality of attributed include one or more of: a frequency of an exercise, a cadence of an exercise reps of the exercise, sets of the exercise, rest for the exercise, an age group, a goal, a medical history, an experience level, an endurance level, a fitness level, or an availability.

13. The method of claim 1, wherein the subject matter expert has expertise in a particular subject.

14. The method of claim 13, wherein:
the particular subject is exercise and the subject matter expert is a trainer;
the particular subject is travel and the subject matter expert is a travel guide;
the particular subject is cooking and the subject matter expert is a chef;
the particular subject is education and the subject matter expert is a teacher; or
the particular subject is instructional and the subject matter expert is an instructor.

15. In a system that delivers media content including an individualized media file for a particular subject to a subscriber, a method of collecting data from a subject matter expert for the subject of the media content, the method comprising:
storing common content in a knowledge base, wherein the common content is related to a particular subject and is maintained by a first subject matter expert;
providing an interface application to a second subject matter expert, wherein the interface application accesses the common content to populate one or more fields on a user interface;
receiving input from the second subject matter expert, the input selecting at least some of the common content for inclusion in a method for the particular subject; and
storing the method in the knowledge base as at least one media clip.

16. The method of claim 15, wherein storing common content in a knowledge base further comprising providing establishing one or more tables for storing the common content.

17. The method of claim 15, wherein providing an interface application to a second subject matter expert further comprises presenting a grid based user interface to the second subject matter expert.

18. The method of claim 17, further comprising including fields in the grid based user interface, wherein at least one of the fields is pre-populated with some of the common content, wherein selection of specific common content defines a philosophy of the second subject matter expert.

19. The method of claim 15, wherein receiving input from the second subject matter expert further comprises recording at least one media clip, each media clip associated with a method provided by the second subject matter expert.

20. The method of claim 19, wherein each method defined by the second subject matter expert for the particular subject includes a plurality of attributes that include one or more of a frequency, a cadence, reps, sets, a rest, an age group, a goal, a medical history, an experience level, an endurance level, a fitness level, or an availability.

21. The method of claim 19, further comprising generating personalized media content by selecting one or more methods of at least the second subject matter expert having attributes that match attributes of a subscriber.

22. The method of claim 15, wherein the subject is exercise and the second subject matter expert is a trainer.

23. In a system that delivers media content including an individualized media file for a particular subject to a subscriber, a method of modeling data from a subject matter expert such that media content can be dynamically generated for a subscriber, the method comprising:
receiving content from a subject matter expert, the content related to a particular subject;
identifying variables in the content, wherein the variables in the content are related to attributes associated with one or more subscribers; and
storing clips of the content in a knowledge base, each clip related to at least one variable aspect of the content.

24. The method of claim 23, further comprising generating media content for a subscriber, the media content including one or more of the variables identified in the content, wherein the variables included in the media content are identified according to attributes associated with the subscriber.

25. The method of claim 24, wherein identifying variables in the content further comprises identifying reasons for the variables in the content, wherein the reasons are associated with the attributes associated with the subscriber.

26. The method of claim 24, further comprising producing a workout sequence by selecting one or more of the clips based on at least one of a goal of the subscriber, attributes of the subscriber, a status of the subscriber, and a selected subject matter expert.
